(19) United States
(12) Patent Application Publication
(10) Pub. No.: US 2007/0111743 A1
(43) Pub. Date: May 17, 2007

(54) Mobile-Device Directed Conference Call Interface

(76) Inventors: Randolph J. Leigh, Monument, CO (US); Thomas Ray Miller, Colorado Springs, CO (US); David Guthrie, Atlanta, GA (US); J. Scott Tapp, Atlanta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/380,160

(22) Filed: Apr. 25, 2006

Related U.S. Application Data
(63) Continuation-in-part of application No. 11/273,163, filed on Nov. 14, 2005.

(51) Int. Cl. H04L 12/16; H04B 7/00

(52) U.S. Cl. 455/518; 370/260

(57) ABSTRACT

A telecommunication system includes a processor, interfaces in communication with the public telephone network and a data network, respectively, and a memory. The memory comprises executable instructions that when executed by the processor direct the system to establish a conference call, confirm the identity of a moderator of the conference call and upon successful confirmation of the identity of the moderator, expose call features that are inaccessible to remaining participants of the conference call.

### BACKGROUND

Audio conferences via a switched telephone network are in widespread use. The conference may be accomplished by use of a multi-line telephone or by a conference bridge having a telephone number that can be called by all conference participants. Typically, the teleconferencing service provider allocates one or more personal identification numbers (PINs) to subscribers and connects each subscriber to their intended conference based on the PIN entered by the subscriber, through equipment known as a teleconferencing bridge. A conference usually includes a host who organizes or leads the conference and a number of guests. The host may often have additional privileges beyond those of the guests, such as, for example, being able to add or remove guests from the conference. The conference host can be distinguished from the guests by having a PIN that is different from the PIN or PINs assigned to the guests.

Many telecommunications carriers and service providers offer conference call services whereby three or more callers may participate in the same call. To establish a conference call, a host typically arranges with a telecommunications carrier or other service provider to reserve a number of connections (i.e., ports) on a telecommunications bridge, which combines (bridges) a plurality of telephone calls. The host may manually interact with an operator of the telecommunications carrier who, in turn, undertakes the necessary steps to reserve the required number of ports on a particular bridge. Alternatively, a host may reserve the requisite number of bridge ports by interacting with an automated system. Once the host has reserved the requisite number of ports on the bridge, each participant (including the host) enters the conference call by directly dialing a telephone number associated with the bridge to be connected to a bridge port. Upon receipt of a call, the bridge authenticates the caller by prompting for an identifier in the form of an access code. Only when the caller enters the proper access code for the particular conference call does the bridge connect the caller with others who have already joined the conference call.

To enter the conference call, each participant must know both the telephone number of the bridge as well as the requisite access code. In practice, the host often receives a separate access code from the other participants to afford the host the ability to control various aspects of the call. Before a scheduled conference call, the host must communicate the bridge number and access code to each participant. For a large number of participants, ensuring that each scheduled participant receives the bridge number and participant code can prove cumbersome, particularly for participants at different locations. The problem of notifying all the conference participants of the conference bridge number and access code becomes even more pronounced for conference calls that occur on a frequent basis, such as every week or even every day. To alleviate this difficulty, some carriers allow the host to reserve the same bridge and use the same participant code. However, not all carriers afford every conference call host the ability to reserve the same bridge for every conference call.

To obviate the need to communicate the bridge number to every participant, some telecommunications carriers that provide conference call services will automatically launch a call to each participant at the start of the conference call. This approach works well for participants whose locations and telephone numbers are known in advance of the conference call. Unfortunately, telecommunications carriers that provide this type of conference call service may not know the location of every intended participant at the outset of the conference call. For example, the host and one or more invited participants may be away traveling, yet available to participate from a mobile telephone.

Thus, there is a need for an enhanced conference call service that allows mobile telephone subscribers to host a conference call from any location.

### SUMMARY

An embodiment of a telecommunication system comprises a processor, a first interface in communication with a public-telephone network, a second interface in communication with a data network and a memory. The memory comprises executable instructions that when executed by the processor direct the system to establish a conference call, confirm the identity of a moderator of the conference call and upon successful confirmation of the identity of the moderator, expose call features that are accessible to the moderator and inaccessible to participants of the conference call without moderator privileges.

An embodiment of a method for controlling a conference call comprises receiving information from a subscriber of a mobile-communication service, the information identifying the subscriber as one with moderator privileges and providing executable instructions to a mobile-communication device associated with the subscriber, the executable instructions configured to interact with one or more interfaces of the mobile-communication device to expose a call feature that is accessible to subscribers with moderator privileges and inaccessible to the remaining participants of a conference call.

Other systems, methods, features and advantages will be or will become apparent to one with skill in the art upon examination of the following figures and detailed description. All such additional systems, methods, features and advantages are defined by the accompanying claims.

### BRIEF DESCRIPTION OF THE FIGURES

The mobile-device directed conference call interface and methods for controlling a conference call can be better understood with reference to the following figures. The functions within the various figures are not necessarily performed in the order presented, emphasis instead being placed upon clearly illustrating the principles used to enable and manage conference calls from a mobile-communication device. Moreover, in the figures, like reference numerals designate corresponding parts throughout the different views.

FIG. 1 is a schematic diagram illustrating an embodiment of a communication system.

FIG. 2 is a block diagram illustrating an embodiment of the teleconference bridge of FIG. 1.

FIG. 3 is a block diagram illustrating an embodiment of the IP-PBX device of FIG. 1.

FIGS. 4A through 4G are schematic diagrams illustrating alternative embodiments of a graphical-user interface on the mobile-communication device of FIG. 1.

FIG. 5 is a flow diagram illustrating an embodiment of a method for mobile-device directed conference calling.

FIG. 6 is a flow diagram illustrating an embodiment of a method for controlling a conference call via a mobile-communication device.

### DETAILED DESCRIPTION

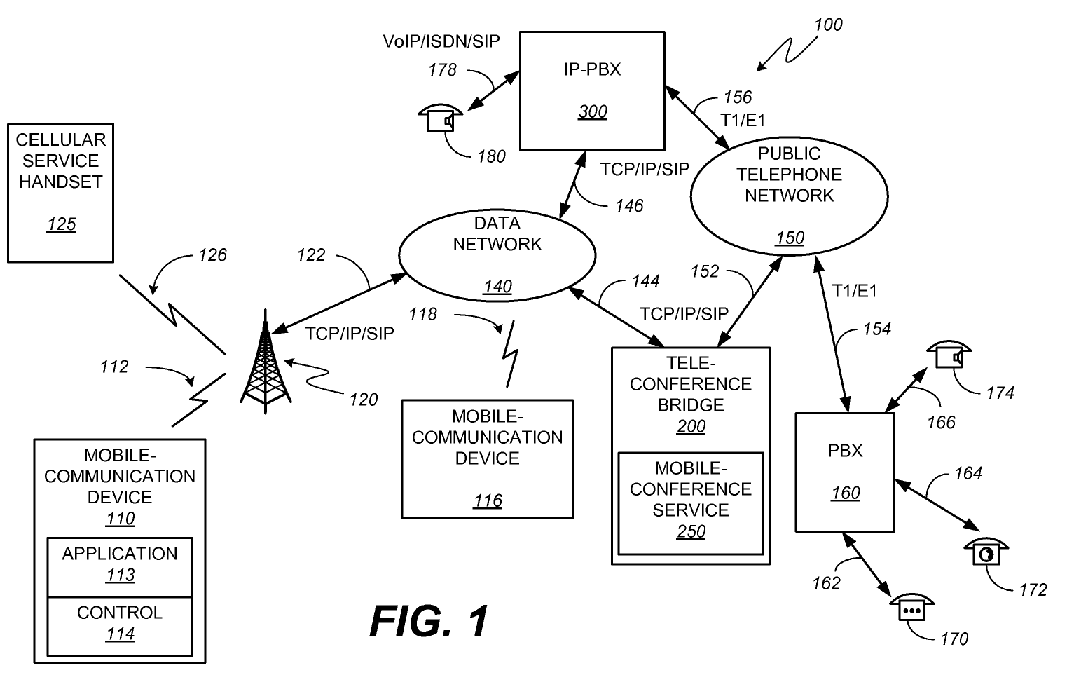

Various embodiments of systems and methods for mobile-device directed conference calling as controlled via an interface enabled on a mobile-communication device will be described with respect to FIGS. 1-6. A mobile, on-demand conference-call service includes one or more mechanisms for a present subscriber of mobile-communication services (i.e., voice or voice and data) to subscribe to an additional service. For example, a customer may complete basic account and service information via a website arranged to collect such information and interact with a service provider's accounting, billing and management functions to subscribe to the on-demand conference-call service.

Once a subscriber has subscribed to the service, an application is sent to the customer's mobile-communication device to enable the service. The application includes logic for integrating various input/output mechanisms available on the device with one or more menus and options that enable an operator to host or attend a conference via the service. The service generates an e-mail message that includes an access number, which is sent to the subscriber. The subscriber enters the access number the first time the subscriber wants to host or attend a conference via the mobile-communication device. Thereafter, the subscriber's mobile-communication device uses the previously entered access number to communicate with the service.

The application installation integrates an option with a primary function menu on the mobile-communication device. When an operator of the mobile-communication device selects the option, the device presents the operator a secondary menu with options to host or attend a conference call. In response to an operator selection of one of the host or attend a conference call options, the mobile-communication device initiates a call using the access number to a teleconference bridge. Entry into the teleconference bridge can be made via a caller identification recognition procedure or a manual or automated dialing of a bridge number and passcode on a telephonic device. Manual or automated dialing permits teleconference bridge access from network locations where caller identification functions are not supported (e.g., overseas). When the caller identification recognition procedure is used, the teleconference bridge authenticates the caller by comparing the mobile-communication device's automatic number identification (ANI) to the subscriber's personal information. When the mobile-communication device belongs to a subscriber of the on-demand conference calling service and the operator has selected the “host” mode of operation, the teleconference bridge assigns appropriate bridge resources to establish and manage a conference call from the mobile-communication device. Otherwise, when the operator of the mobile-communication device has selected the “attend” mode of operation conference call management functions are not exposed to the operator. In some embodiments, the mobile-communication device is programmed such that an operator of the device is prompted to select or otherwise enter a control input to enable the bridge or join the call.

The ANI feature includes information about the originating station as well as the calling party station identifier (a phone number). The information is delivered in-band in the form of dual-tone multiple-frequency (DTMF) or other multiple frequency signals, or out-of-band with the integrated services digital network primary rate interface (ISDN PRI) based services and other data network based telecommunication services (e.g., voice over Internet protocol (VoIP)). When the ANI feature is communicated via out-of-band channels it is generally communicated in a data packet as part of the call configuration data. Data packet based communications can be accomplished via both wired and wireless communication networks. For in-band (e.g., T-1) communications, the ANI transmission format typically includes a key pulse that seizes the circuit followed by an information digit the 7 or 10-digit calling party station number and a start signal or acknowledgement from the network.

In addition to the website arranged to collect information to enroll subscribers, a service provider provides one or more reporting websites that enable a subscriber of the service to retrieve and present usage history, troubleshoot, configure account information, etc.

Having described the general operation of various embodiments for mobile-device directed conference calling; various additional embodiments will be described with respect to FIGS. 1-6. FIG. 1 is a schematic diagram illustrating a communication system 100. As illustrated in FIG. 1, communication system 100 comprises a mobile-communication device 110 in indirect communication with a number of telephonic devices via multiple networks and teleconference bridge 200. Mobile-communication device 110 is in communication with mobile network 120 via radio-frequency link 112. Mobile network 120 can be any available network that supports the use of a portable communication device with data and voice communication features. Mobile network 120 is in communication with cellular service handset 125 via radio-frequency link 126 and data network 140 via communication link 122. Mobile network 120 provides voice and data services to a subscriber with an appropriately configured handset such as cellular service handset 125 and mobile-communication device 110. Although mobile network 120 is depicted as a single tower, it should be understood that mobile network 120 comprises a set of geographically separated communication facilities with supporting communication session control for transferring the communication session from a first facility to a closely located second facility as a subscriber to the mobile network 120 moves from one location to another.

Data network 140 is in communication with Internet protocol-private branch exchange (IP-PBX) bridge 300 via communication link 146 and teleconference bridge 200 via communication link 144. Data network 140 is a wide area network that distributes information to and from coupled devices using indirect packet-based communication protocols such as transmission control protocol/Internet protocol (TCP/IP) and session initiation protocol (SIP). Communication links 122, 144 and 146 may be wired and or wireless communication links. As illustrated in FIG. 1, data network 140 is also in communication with one or more wireless access points that allow an appropriately configured mobile device such as mobile-communication device 116 to communicate via data network 140.

IP-PBX bridge 300 is also in communication with public-telephone network (PTN) 150 via communication link 156, which exposes one or more telephonic user devices to devices coupled to data network 150 and mobile network 120. In the illustrated embodiment, IP-PBX bridge 300 is coupled to speakerphone 180 via communication link 178. It should be understood that IP-PBX bridge 300 can be configured with multiple ports capable of communicating via wired and wireless communication media to additional telephonic devices. Telephonic devices coupled to IP-PBX bridge 300 may communicate using packet-based digital communication protocols such as VoIP, ISDN protocols and session initiation protocol (SIP). SIP is used for establishing, routing, modifying and terminating multimedia communication sessions, such as voice calls, on IP networks. A PBX with a native SIP interface will enable it to support a wide variety of SIP-based products and services, including wireless access points and phones, as well as conference room phones, residential access devices for teleworking, and domestic and international trunking services. SIP trunks connect systems from switch to switch or from switch to wireless access point, and handle the basic requirements such as on hook, off hook, ringing and busy. Handsets, speakerphones, or other end user devices offer many advanced features, such as conference, hold, park, transfer and camp-on that require control messages that go beyond the basic features defined in the SIP protocol.

Teleconference bridge 200, which is coupled to data network 140 via communication link 144 is also in communication with the PTN 150 via communication link 152. Teleconference bridge 200, as will be explained in further detail below, provides mobile-conference service 250 to subscribers of the service coupled to either of mobile network 120, data network 140 and PTN 150.

PTN 150 includes any number of local exchange carrier (LEC) central offices, access tandems, long-distance facilities, and other telecommunication switching systems. For example, PTN 150 includes a plurality of access switching systems, each typically comprised of a No. 4ESS switching system formerly manufactured by Western Electric (now Lucent Technologies, Inc.). Each access switching system is associated with one or more LECs for receiving calls originated by, and for sending calls to, customers served by a respective LEC. The access switching systems are interconnected, either directly or through one or more via switching systems. PTN 150 also includes a signaling network, such as AT&T's SS7 signaling network that includes one or more Signal Transfer Points (STPs) for collecting and routing signaling information, such as call set-up information, between and among the access switching systems and the via switching systems. In addition to the STPs, the signaling network also includes one or more network control points (NCPs) that take the form of databases that store information, including instructions and/or data for access by one or more of the switching systems and via switching systems to facilitate call processing.

As shown in FIG. 1, PBX 160 is in communication with PTN 150 via communication link 154 and with a number of telephonic devices such as speakerphone 174, rotary phone 172, and push-button phone 170. Speakerphone 174 is coupled to PBX 160 via communication link 166. Rotary phone 172 is in communication with PBX 160 via communication link 164. Pushbutton phone 170 is coupled to PBX 160 via communication link 162. Communication links 162, 164 and 166 are generally multiple-conductor wired analog links. It should be appreciated that analog and digital modems may be communicatively coupled to via PBX 160 and communication links 162, 164 and 166 to expose other communication devices such as computers and VoIP enabled handsets to devices coupled to PTN 150, data network 140 and mobile network 120.

Communication system 100 enables mobile-conference service 250 whereby one or more individual subscribers (represented by the various telephone stations and mobile-communication devices) may participate in a conference call. A conference host initiates the conference through the host subscriber's mobile voice and data service provider and teleconference bridge 200. Conference attendees each access the conference call through respective LECs, mobile service carriers, or data service providers.

A conference host communicates with teleconference bridge 200 using application logic 113 and one or more control mechanisms associated with mobile-communication device 110 via control interface 114. Conference attendees contact a particular conference call bridge by entering an access number and one or more other identifiers after establishing a call with teleconference bridge 200. It should be understood that each conference bridge includes a plurality of ports (not shown), that receive individual telephone calls from each of the conference host and one or more conference attendees that are bridged together to enable multiple participants to participate in the same call. When a subscriber of the service is the operator of a mobile-communication device, the device's ANI can be used to authenticate the subscriber, identify a previously scheduled conference and connect the subscriber to the conference. In some embodiments, additional prompts can be pre-programmed into the mobile-communication device interface to enable the subscriber to provide one or more additional codes or other information that the subscriber and/or a conference host would readily be able to provide. When a subscriber is the operator of a communication device that is using VoIP to communicate with teleconference bridge 200, the subscriber will be authenticated when the teleconference bridge 200 receives a proper code or other information associated with a subscriber that is invited to join an identified teleconference.

While the illustrated embodiment of communication system 100 shows mobile network 120 coupled to PTN 150 via data network 140 and one or both of teleconference bridge 200 and IP-PBX 300, those of ordinary skill in the art of networks will understand that mobile network 120 can be otherwise coupled to PTN 150 to complete calls.

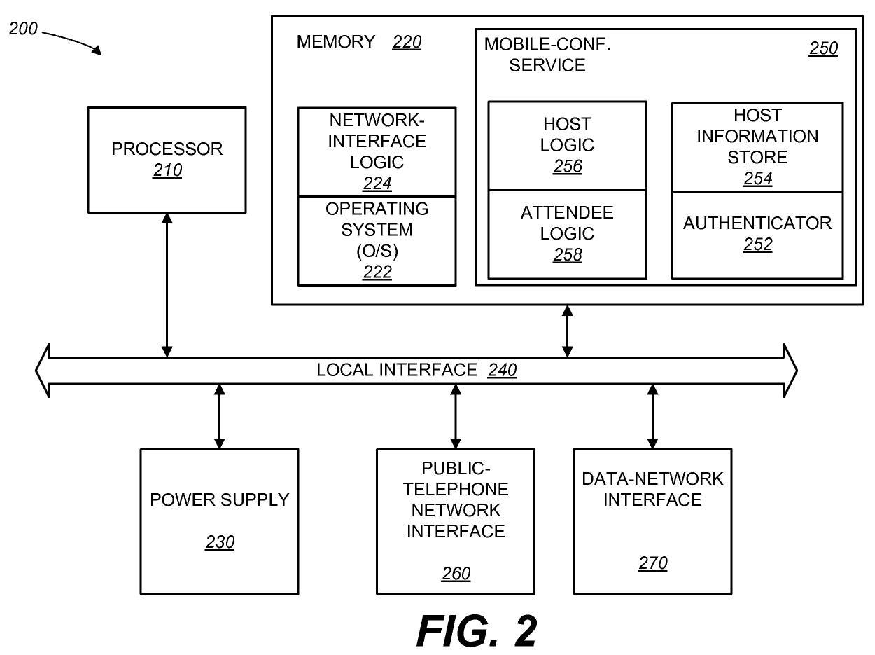

FIG. 2 is a block diagram illustrating an embodiment of the teleconference bridge 200 of FIG. 1. Generally, in terms of hardware architecture, as shown in FIG. 2, teleconference bridge 200 includes processor 210, memory 220, power supply 230, PTN interface 260 and data-network interface 270. Processor 210, memory 220, PTN interface 260 and data-network interface 270 are communicatively coupled via a local interface 240. The local interface 240 can be, for example but not limited to, one or more buses or other wired or wireless connections, as is known in the art. The local interface 240 may have additional elements, which are omitted for simplicity, such as controllers, buffers (caches), drivers, repeaters, and receivers, to enable communications. Further, the local interface 240 may include address, control, and/or data connections to enable appropriate communications among the aforementioned components.

Power supply 230 provides power to each of the processor 210, memory 220, PTN 260, data-network interface 270 and local interface 240 in a manner understood by one of ordinary skill in the art.

Processor 210 is a hardware device for executing software, particularly that stored in memory 220. The processor 210 can be any custom made or commercially available processor, a central processing unit (CPU), an auxiliary processor among several processors associated with the teleconference bridge 200, a semiconductor based microprocessor (in the form of a microchip or chip set), or generally any device for executing software instructions.

The memory 220 can include any one or combination of volatile memory elements (e.g., random-access memory (RAM), such as dynamic random-access memory (DRAM), static random-access memory (SRAM), synchronous dynamic random-access memory (SDRAM), etc.) and nonvolatile memory elements (e.g., read-only memory (ROM), hard drive, tape, compact disk read-only memory (CD-ROM), etc.). Moreover, the memory 220 may incorporate electronic, magnetic, optical, and/or other types of storage media. Note that the memory 220 can have a distributed architecture, where various components are situated remote from one another, but can be accessed by the processor 210.

The software in memory 220 may include one or more separate programs, each of which comprises an ordered listing of executable instructions for implementing logical functions. In the example of FIG. 2, the software in the memory 220 includes operating system 222, network-interface logic 224 and mobile-conference service 250. The operating system 222 essentially controls the execution of other computer programs, such as network-interface logic 224 and mobile-conference service 250 and provides scheduling, input-output control, file and data management, memory management, and communication control and related services.

Network-interface logic 224 comprises one or more programs and one or more data elements that enable the mobile-conferencing service 250 to communicate with external devices via PTN interface 260 and data-network interface device 270. In this regard, network-interface logic 224 may include one or buffers and parameter stores for holding configuration information and or data as may be required.

Mobile-conference service 250 includes host logic 256, attendee logic 258, authenticator 252 and subscriber information store 254. Authenticator 252 extracts the ANI and compares the extracted ANI with subscriber information store 254 to ensure that an operator of a communication device that is communicating with teleconference bridge 200 is a subscriber of the on-demand mobile-conference calling service. When it is desired to use additional mechanisms to secure the service, authenticator 252 may initiate a prompt which is communicated to the calling party using the communication device to enter a security code or other identifying information. The security code or other identifying information is stored within subscriber information store 254. Host logic 256 includes executable instructions for establishing and managing a conference call from a conference host. Host logic 256 includes logic for responding to various PTN 150 and data network 140 control signals, and inputs entered from host subscribers. Inputs entered from host subscribers include a list of conference call control commands that are issued via a communication device such as mobile-communication device 110 that are exposed to host subscribers. Some of these commands are issued by entering a multiple-digit code using one or more controls available on mobile-communication device 110. Other commands may be issued in direct response to the selection of an option via a menu presented on a graphical-user interface on mobile-communication device 110. Attendee logic 258 includes executable instructions for connecting to a conference call. Attendee logic 256 includes logic for responding to various PTN 150 and data network 140 control signals, and inputs entered from conference attendees. Conference attendees may or may not be subscribers of the mobile-conference calling service. Inputs entered by attendees are limited to control of the communication device being used to contact teleconference bridge 200.

Network-interface logic 224, host logic 256, attendee logic 258 and authenticator 252 are source programs, executable programs (object code), scripts, or any other entities comprising a set of instructions to be performed. When implemented as source programs, the programs are translated via a compiler, assembler, interpreter, or the like, which may or may not be included within the memory 220, so as to operate properly in connection with the O/S 222. Furthermore, network-interface logic 224 and mobile-conference service 250 can be written in one or more object oriented programming languages, which have classes of data and methods, or procedure programming languages, which has routines, subroutines, and/or functions. In the currently contemplated best mode, network-interface logic 224 and mobile-conference service 250 are implemented in software, as executable programs executed by processor 210.

PTN interface 260 enables teleconference bridge 200 to communicate with various devices, including IP-PBX 300, over PTN 150 (FIG. 1) via connection 152. The PTN interface 260 performs a variety of functions including, for example: answering a phone line; hanging-up a phone line; dialing a phone number; sending fax data; receiving fax data; sending data signals; receiving data signals; generating DTMF tones; detecting DTMF tones; receiving ANI and DNIS, playing voice messages; and converting voice signals between analog and digital formats.

Data-network interface 270 enables teleconference bridge 200 to communicate with various devices, including IP-PBX 300 over the data network 140 (FIG. 1) via connection 144. The data-network interface 270 performs the signal conditioning and format conversions to communicate data through the data network 140. An example data-network interface 270 is compatible with the 100BaseT Ethernet standard and the TCP/IP protocol. It should be understood that other data-network interfaces including, for example and without limitation, wired and wireless data-network interfaces, analog-network interfaces, digital data-network interfaces, optical data-network interfaces, and network interfaces compatible with other hardware and software standards and protocols may also be used.

When teleconference bridge 200 is in operation, the processor 210 is configured to execute software stored within the memory 220, to communicate data to and from the memory 220, and to generally control operations of the teleconference bridge 200 pursuant to the software. The network-interface logic 224, mobile-conference service 250 and the O/S 222, in whole or in part, but typically the latter, are read by the processor 210, perhaps buffered within the processor 210, and then executed.

When the network-interface logic 224 and mobile-conference service 250 are implemented in software, as is shown in FIG. 2, it should be noted that these software elements can be stored on any computer-readable medium for use by or in connection with any computer related system or method. In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a RAM (electronic), a ROM (electronic), an erasable programmable read-only memory (EPROM), an electrically erasable programmable read-only memory (EEPROM), or Flash memory) (electronic), an optical fiber (optical), and a CDROM (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where one or more of the network-interface logic 224 and mobile-conference service 250 are implemented in hardware, the network-interface logic 224 and mobile-conference service 250 can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field-programmable gate array (FPGA), etc.

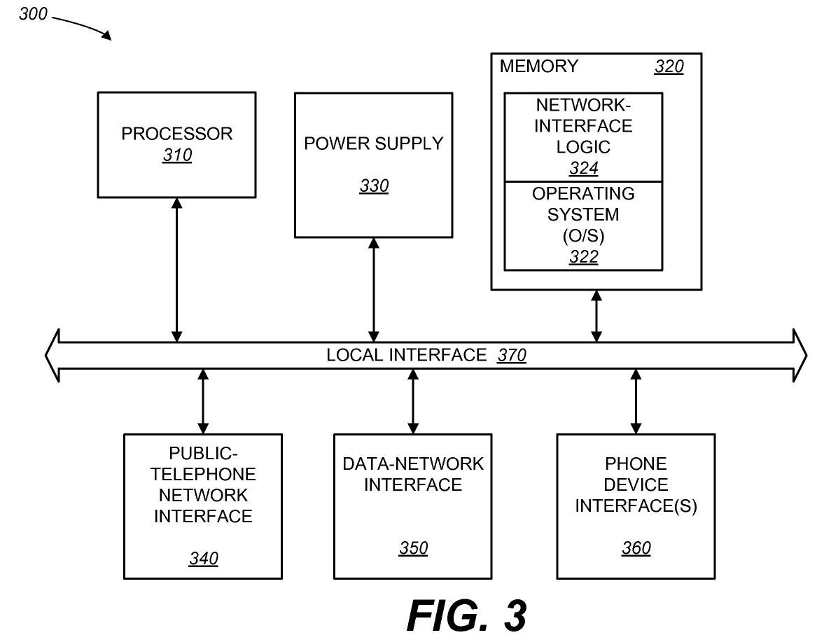

FIG. 3 is a block diagram illustrating an embodiment of the IP-PBX bridge 300 of FIG. 1. Generally, in terms of hardware architecture, as shown in FIG. 3, IP-PBX bridge 300 includes processor 310, memory 320, power supply 330, PTN interface 340, data-network interface 350, and phone device interface(s) 360. Processor 310, memory 320, PTN interface 340, data-network interface 350, and phone device interface(s) 360 are communicatively coupled via a local interface 370. The local interface 370 can be, for example but not limited to, one or more buses or other wired or wireless connections, as is known in the art. The local interface 370 may have additional elements, which are omitted for simplicity, such as controllers, buffers (caches), drivers, repeaters, and receivers, to enable communications. Further, the local interface 370 may include address, control, and/or data connections to enable appropriate communications among the aforementioned components.

Power supply 330 provides power to each of the processor 310, memory 320, PTN interface 340, data-network interface 350, phone device interface(s) 360 and local interface 370 in a manner understood by one of ordinary skill in the art.

Processor 310 is a hardware device for executing software, particularly that stored in memory 320. The processor 310 can be any custom made or commercially available processor, a CPU, an auxiliary processor among several processors associated with the IP-PBX bridge 300, a semiconductor based microprocessor (in the form of a microchip or chip set), or generally any device for executing software instructions.

The memory 320 can include any one or combination of volatile memory elements (e.g., RAM, such as DRAM, SRAM, SDRAM, etc.)) and nonvolatile memory elements (e.g., ROM, hard drive, tape, CDROM, etc.). Moreover, the memory 320 may incorporate electronic, magnetic, optical, and/or other types of storage media. Note that the memory 320 can have a distributed architecture, where various components are situated remote from one another, but can be accessed by the processor 310.

The software in memory 320 may include one or more separate programs, each of which comprises an ordered listing of executable instructions for implementing logical functions. In the example of FIG. 3, the software in the memory 320 includes operating system 322 and network-interface logic 324. The operating system 322 essentially controls the execution of other computer programs, such as network-interface logic 324 and provides scheduling, input-output control, file and data management, memory management, and communication control and related services.

Network-interface logic 324 comprises one or more programs and one or more data elements that enable the IP-PBX bridge 300 to receive and forward communication streams between mobile network 120, data network 140 and PTN 150. In this regard, network-interface logic 324 may include one or buffers and parameter stores for holding configuration information and or data as may be required. Network-interface logic 324 is a source program, executable program (object code), script, or any other entity comprising a set of instructions to be performed. When implemented as a source program, the program is translated via a compiler, assembler, interpreter, or the like, which may or may not be included within the memory 320, so as to operate properly in connection with the O/S 322. Furthermore, network-interface logic 324 can be written in one or more object-oriented programming languages, which have classes of data and methods, or procedure programming languages, which has routines, subroutines, and/or functions. In the currently contemplated best mode, network-interface logic 324 is implemented in software, as an executable program executed by processor 310.

PTN interface 340 enables IP-PBX bridge 300 to communicate with various devices, including teleconference bridge 200, over the PTN 150 (FIG. 1) via connection 156. The PTN interface 340 performs a variety of functions including, for example: answering a phone line; hanging-up a phone line; dialing a phone number; sending data signals; receiving data signals; generating DTMF tones; detecting DTMF tones; receiving ANI and DNIS signals; and playing voice messages.

Data-network interface 350 enables IP-PBX bridge 300 to communicate with various devices, including devices coupled to teleconference bridge 200, over the data network 140 (FIG. 1) via connection 146. The data-network interface 350 performs the signal conditioning and format conversions to communicate data through the data network 140. An example data-network interface 350 is compatible with the 100BaseT Ethernet standard and the TCP/IP protocol. It should be understood that other data-network interfaces including, for example and without limitation, wired and wireless data-network interfaces, analog network interfaces, digital data-network interfaces, optical data-network interfaces, and network interfaces compatible with other hardware and software standards and protocols may also be used.

When IP-PBX bridge 300 is in operation, the processor 310 is configured to execute software stored within the memory 320, to communicate data to and from the memory 320, and to generally control operations of the IP-PBX bridge 300 pursuant to the software. The network-interface logic 324 and the O/S 322, in whole or in part, but typically the latter, are read by the processor 310, perhaps buffered within the processor 310 and then executed.

When the network-interface logic 324 is implemented in software, as is shown in FIG. 3, it should be noted that the network-interface logic 324 can be stored on any computer-readable medium for use by or in connection with any computer related system or method. In an alternative embodiment, where the network-interface logic 324 is implemented in hardware, the network-interface logic 324 can be implemented with any or a combination of the following technologies, which are each well known in the art: a discrete logic circuit(s) having logic gates for implementing logic functions upon data signals, an ASIC having appropriate combinational logic gates, a PGA, a FPGA, etc.

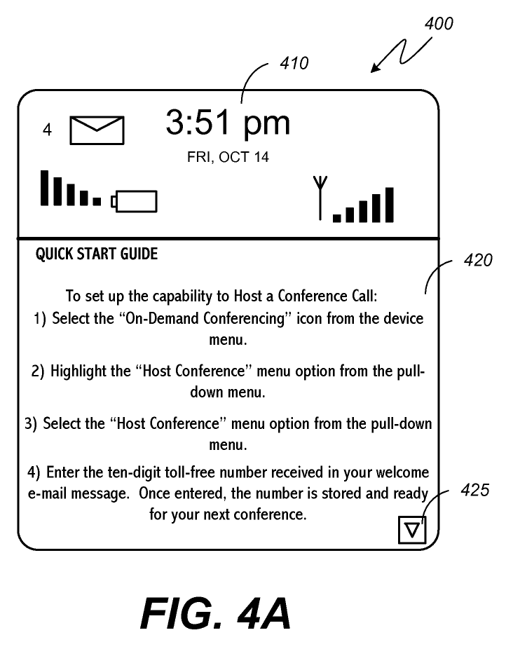

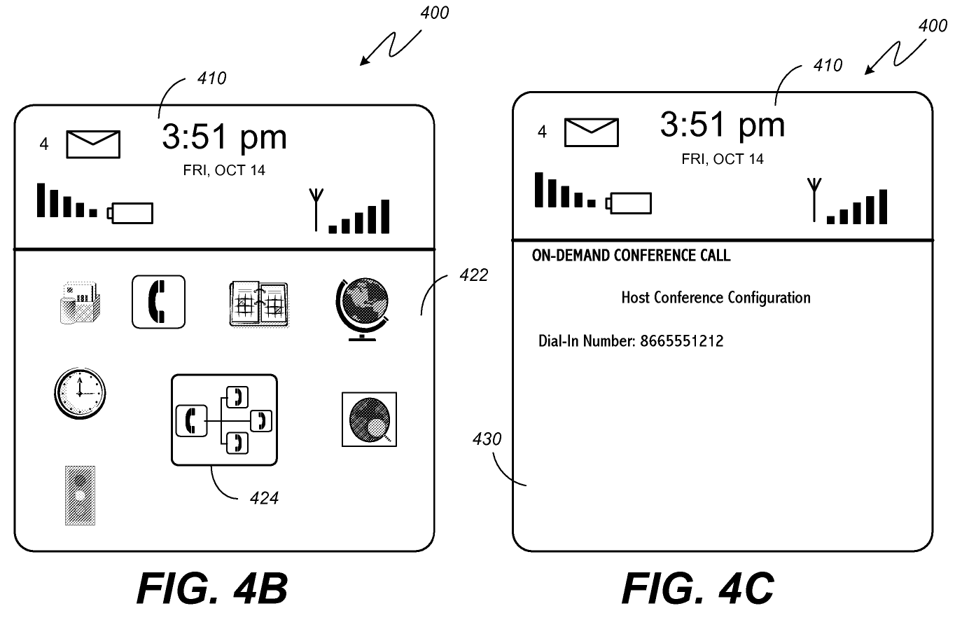

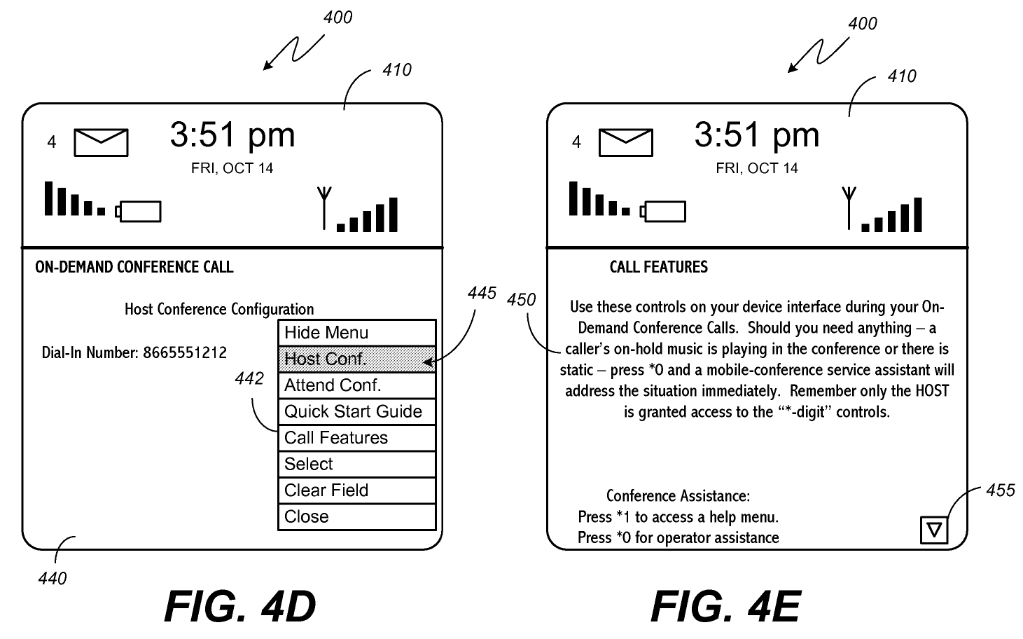

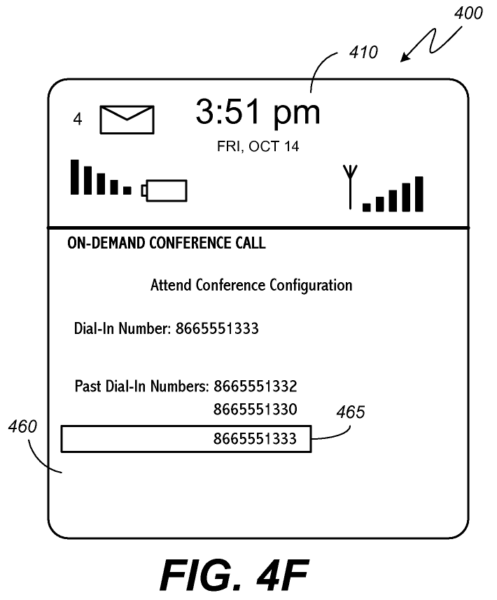

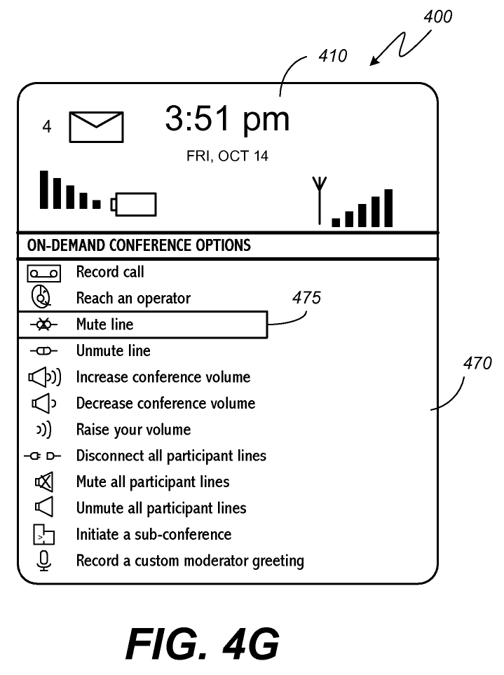

FIGS. 4A through 4G are schematic diagrams illustrating embodiments of a graphical-user interface 400 on the mobile-communication device 110 of FIG. 1. FIG. 4A is a schematic diagram illustrating an embodiment of a graphical-user interface on the mobile-communication device 110 of FIG. 1. As illustrated in FIG. 4A, graphical-user interface 400 comprises a header 410 and frame 420. Header 410 provides information that is consistently updated and displayed while mobile-communication device 110 is activated and functioning in a message handling mode of operation. Header 410 comprises time, day and date information as well as a message storage field that shows how many new messages have been received and stored on mobile-communication device 110. Header 410 also includes battery and signal indicators, which provide a visual indication of battery and received signal strength.

Frame 420 presents a text narrative that conveys a quick start guide concerning operation of the conference calling service mobile-conference call service. Included in frame 420 is scroll indicator 425 indicating that additional information within the quick start guide is available. When an operator of mobile-communication device 110 uses a control to selectively scroll down through the quick start guide narrative, a second scroll indicator (not shown) is added to the upper right of frame 420. The second scroll indicator is presented when it is the case that an upper portion of the quick start guide is not rendered within frame 420.

FIG. 4B illustrates a second embodiment of the graphical-user interface 400 as rendered and presented on a display associated with mobile-communication device 110. Graphical-user interface 400 comprises header 410 and frame 422. Frame 422 presents a main menu of tools and modes of operation available to and selectable by an operator of mobile-communication device 110. An operator of mobile-communication device 110 can navigate through the main menu by using a position control associated with the mobile-communication device to controllably position window 424 over an icon representing a desired function. In the illustrated embodiment, an operator of the mobile-communication device 110 has moved position window 424 over an icon representing an on-demand conference call. FIG. 4C shows graphical-user interface 400 after an operator of the mobile-communication device has selected a host conference call mode of operation and entered a dial-in number via one or more controls available on the mobile-communication device 110. In one embodiment, the dial-in number is stored within an address book on the mobile-communication device 110 and is identical to the access number provided to the subscriber when the operator of the mobile-communication device 110 subscribed to the on-demand mobile conference call service.

FIG. 4D shows graphical-user interface 400 after an operator of the mobile-communication device 110 has used one or more controls available on the mobile-communication device to initiate pull-down menu 442. Pull-down menu 442 includes a number of options for selecting various operational modes, configuring features and managing the menu and on-demand mobile-conference calling service. As illustrated in FIG. 4D an operator of mobile-communication device 110 selects pull-down menu options by controllably positioning highlight bar 445 over a desired option and entering a “select” control input available on the mobile-communication device.

FIG. 4E shows graphical-user interface 400 after an operator of the mobile-communication device 110 has used one or more controls available on the mobile-communication device to select the “Call Features” option from the pull-down menu 442 (FIG. 4D). Graphical-user interface 400 includes frame 450 which presents a narrative explaining how a conference call host can contact a mobile conference call service assistant. Included in frame 450 is scroll indicator 455 indicating that additional information within the call features narrative is available. When an operator of mobile-communication device 110 uses a control to selectively scroll down through the call features narrative, a second scroll indicator (not shown) is added to the upper right of frame 450. The second scroll indicator is presented when it is the case that an upper portion of the call features narrative is not rendered within frame 450. Additional multiple digit codes other than those shown in FIG. 4E may be operational via mobile-communication device 110.

FIG. 4F shows graphical-user interface 400 after an operator of the mobile-communication device 110 has used one or more controls available on the mobile-communication device to select the “Attend Conference” option from the pull-down menu 442 (FIG. 4D) and entered a dial-in number. Graphical-user interface 400 includes frame 460 which presents a list of previously used dial-in numbers as entered on the mobile-communication device 110. As illustrated in FIG. 4F, an operator of the mobile-communication device 110 can use one or more control inputs to controllably position selection frame 465 over a desired dial-in number present in the list and select the number. Thereafter, application 113 will initiate a call to the teleconference bridge 200 and if appropriate add the caller to a conference call.

FIG. 4G shows graphical-user interface 400 generated and rendered a display associated with mobile-communication device 110 for presentation to a conference call moderator, while the conference call is being actively managed by teleconference bridge 200. Graphical-user interface 400 comprises header 410 and frame 470. Frame 470 presents an interactive menu of conference call controls (i.e., modes of operation) available to and selectable by an operator of mobile-communication device 110 with moderator privileges. An operator of mobile-communication device 110 can navigate through the main menu by using a position control associated with the mobile-communication device to controllably position window 475 over an icon and description associated with a desired function. In the illustrated embodiment, an operator of the mobile-communication device 110 has moved position window 475 over an icon representing a conference call control that mutes the microphone associated with the moderator's mobile communication device 110. Additional conference call controls include options to record the conference call, reach a teleconference bridge operator, unmute the moderator's microphone, increase conference volume, decrease conference volume, raise the moderator's volume, disconnect participant lines, mute participant lines, unmute participant lines, initiate a sub-conference, and record a custom moderator greeting.

While the graphical-user interfaces presented in FIGS. 4A through 4G show specific embodiments of frames, menu options, fields, etc., it will be appreciated that any number of fields, menus, options, or messages might be added to the interfaces described herein, for purposes of enhanced utility, accounting, troubleshooting, etc. All such variations are within the scope of the present systems and methods for mobile-device directed conference calling.

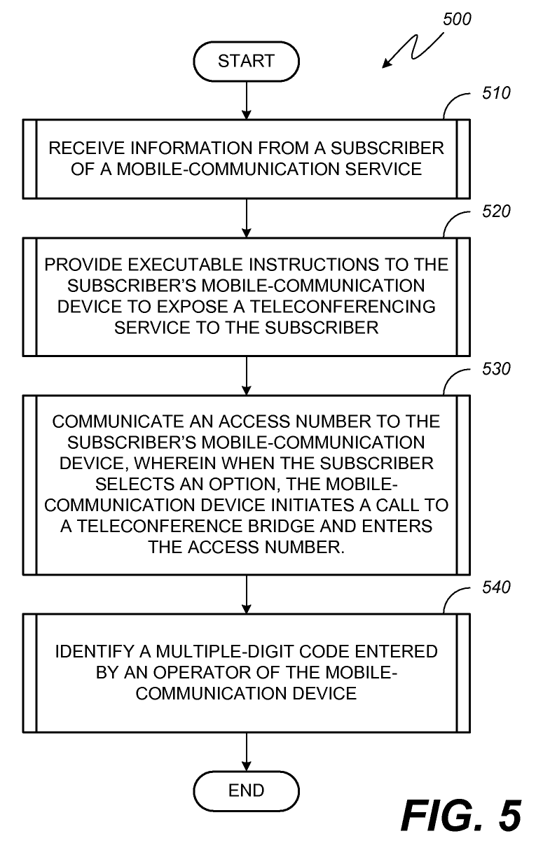

FIG. 5 is a flow diagram illustrating an embodiment of a method for mobile-device directed conference calling. The flow diagram of FIG. 5 shows the architecture, functionality, and operation of a possible implementation via software and or firmware associated with communicatively coupled hardware devices that enable an operator of a mobile-communication device to attend or host a conference call. In this regard, each block represents a module, segment, or portion of code, which comprises one or more executable instructions for implementing the specified function(s).

Method 500 begins with block 510 where a service provider receives information from a subscriber of a mobile-communication service. In some embodiments, the mobile-communication device is a cellular telephone and the service provider is the provider of cellular phone service. As indicated in block 520, a service provider provides executable instructions to the subscriber's mobile-communication device to expose a conference. Typically, the service provider forwards a self-installing application or otherwise provides a Java application on the mobile-communication device 110. In block 530, the service provider communicates an access number to the subscriber's mobile-communication device 110. The access number is then used by the application on the mobile-communication device 110 to initiate a call with teleconference bridge 200. Additional identifiers such as an optional security code may also be forwarded from the service provider to the subscriber. For example, an optional security code can be communicated in correspondence via mail, email, or during an interactive session over the data network 140 using a browser. The optional security code can be used as an additional mechanism for ensuring that the operator of mobile-communication device 110 is a subscriber of the mobile-conference calling service. Once, the steps illustrated and described in association with blocks 510, 520 and 530 are complete; an operator of the mobile-communication device 110 can use the on-demand mobile-conference calling service by contacting the teleconference bridge 200.

When operable, the mobile-communication device, via the Java application, communicates with teleconference bridge 200 to enable an operator of the mobile-communication device 110 to host or attend a conference enabled by the teleconference bridge 200. When the operator of the mobile-communication device 110 has entered a host mode, the mobile-communication device 110 responds to one or more operator inputs with menus and or menu options as described above. Optionally, as indicated in block 540, the teleconference bridge 200 is programmed to identify multiple digit codes entered by an operator of the mobile-communication device 110 and responds in accordance with a pre-determined function. For example, when an operator of the mobile-communication device 110 desires to contact a party that has not yet joined a current conference call, the operator may enter a menu that enables the operator to forward a party's telephone number by entering “*95” after selecting a telephone number stored on the mobile-communication device 110. Upon receipt of the telephone number and the “*95” code entered by the operator of the mobile-communication device 110 initiates a call to the designated party. If the call is answered, the teleconference bridge 200 invites the called party to join the conference call and instructs the called party how to be added to the call. It should be understood that the Java application on the mobile-communication device 110 can be configured to support a number of additional conference call management controls that can be selected and manipulated via the mobile-communication device 110.

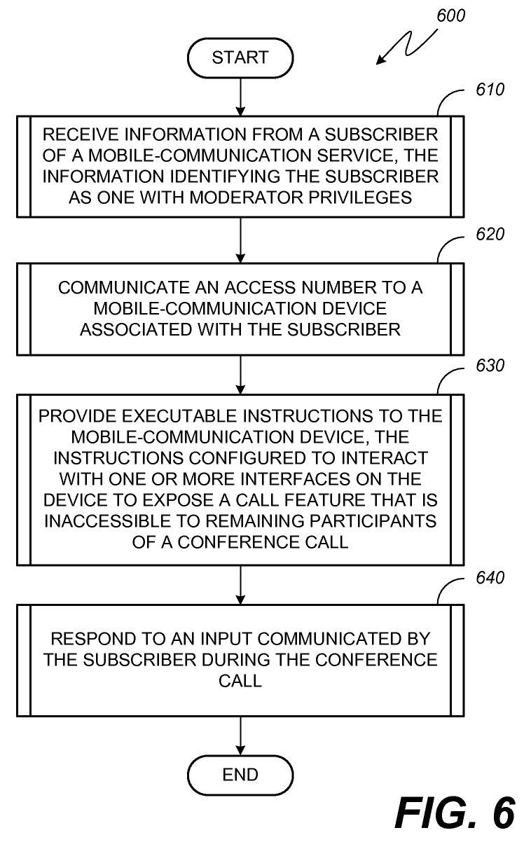

FIG. 6 is a flow diagram illustrating an embodiment of a method for controlling a conference call via a mobile-communication device. The flow diagram of FIG. 6 shows the architecture, functionality, and operation of a possible implementation via software and or firmware associated with communicatively coupled hardware devices that enable an operator of a mobile-communication device to control one or more call features during a conference call. In this regard, each block represents a module, segment, or portion of code, which comprises one or more executable instructions for implementing the specified function(s).

Method 600 begins with block 610 where a service provider receives information from a subscriber of a mobile-communication service. The received information identifies the subscriber as a party having moderator privileges. In some embodiments, the mobile-communication device is a cellular telephone and the service provider is the provider of cellular phone service. As indicated in block 620, a service provider communicates an access number to a mobile-communication device associated with the subscriber. In block 630, the service provider provides executable instructions to the subscriber's mobile-communication device to expose a conference call feature that is inaccessible to remaining participants of a conference call. The instructions interact with one or more interfaces on the mobile-communication device to expose conference call control features to the subscriber. Typically, the service provider forwards a self-installing application or otherwise provides a Java application on the mobile-communication device 110. In block 640, the service provider responds to an input communicated by the subscriber during the conference call. Note that the input can be entered via one or more controls that enable the operator of the mobile-communication device to navigate and controllably select an option presented on a display. In addition, the input can be entered via a combination of alphanumeric symbols commonly associated with telephonic devices. For example, Table I below, titled, “Moderator Features,” includes a listing of example codes each with an associated conference call feature.

TABLE I
Moderator Features

(*0) to reach an operator
(*6) to mute or “un-mute” lines
(*4/*7) to increase or decrease conference volume
(*5/*8) to increase or decrease your voice volume
(*9) to menu of options
(*91) to hear participant count
(*92) to hear roll call of participants
(*93) to disconnect all participant lines
(*94) to lock or unlock conference
(*95) to dial out to participants (select from list)
(*96) to mute all participant lines
(*97) to “un-mute” all participant lines
(*98) scheduled recording
(*99) edit mod security code
(*21) to initiate a sub conference and (#0) to end it
(*22) to Record/Playback
(*31) to turn Conference Security Code (part sec code) on/off
(*32) to record a custom moderator greeting

The teleconference bridge 200 including the mobile-conference service 250, and associated methods for mobile-device directed conference calling may be embodied in software or code executed by general purpose hardware as discussed above, or may be embodied in dedicated hardware such as mobile-communication device 110 and teleconference bridge 200 or a combination of software/general purpose hardware and dedicated hardware. If embodied in hardware, the methods for mobile-device directed conference calling may be expressed or implemented as a circuit or state machine that employs any one of or a combination of a number of technologies. These technologies may include, but are not limited to, discrete logic circuits having logic gates for implementing various logic functions upon an application of one or more data signals, ASICs having appropriate logic gates, PGAs, FPGAs, or other technologies. Such technologies are generally well known by those of ordinary skill in the art.

As described above, the flow diagrams of FIGS. 5 and 6 show the architecture, functionality and operation of an implementation of alternative example methods for mobile-device directed conference calling. The program instructions may be embodied in source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

While the flow diagrams of FIGS. 5 and 6 show specific sequences of execution, it will be appreciated that two or more steps in the diagram that are shown executed in succession may be executed concurrently or with partial concurrence. In addition, any number of counters, state variables, warning semaphores, or messages might be added to the logical flow described herein, for purposes of enhanced utility, accounting, performance measurement, troubleshooting, etc. All such variations are within the scope of the present systems and methods for providing a conference call service to an operator of a mobile-communication device. The flow diagrams may be used by one of ordinary skill in the art to create software and/or hardware to carry out the various logical functions described and illustrated.

While various embodiments of the systems and methods for controlling a conference call have been described, it will be apparent to those of ordinary skill in the art that many more embodiments and implementations are possible that are within the scope of the accompanying claims. Accordingly, the systems and methods for controlling a conference call are not to be restricted beyond the attached claims and their equivalents.

What is claimed is:

1. A telecommunication system, comprising:
a processor;
a first interface in communication with the processor and a public-telephone network;
a second interface in communication with the processor and a data network, the data network further coupled to a mobile-communication device; and
a memory in communication with the processor, the memory comprising executable instructions that when executed by the processor direct the system to establish a conference call, confirm the identity of a moderator of the conference call and upon successful confirmation of the identity of the moderator, expose a call feature that is inaccessible to remaining participants of the conference call.

2. The telecommunication system of claim 1, wherein the memory exposes a call feature via a mobile-device interface to the moderator.

3. The telecommunication system of claim 1, wherein the memory further comprises executable instructions that when executed by the processor monitor the call for one or more select dual-tone multiple frequency (DTMF) encoded signals entered by the moderator.

4. The telecommunication system of claim 3, wherein the memory further comprises executable instructions that when executed by the processor respond in a designated manner when the one or more select DTMF encoded signals entered by the moderator are present.

5. The telecommunication system of claim 1, wherein the second interface uses session initiated protocol.

6. The telecommunication system of claim 1, wherein the second interface receives information from the mobile-communication device via a short-range radio-frequency signal associated with a local area network.

7. The telecommunication system of claim 1, wherein the second interface receives information from the mobile-communication device via a cellular voice and data network.

8. The telecommunication system of claim 1, wherein the second interface receives operator input via a control on the mobile-communication device.

9. The telecommunication system of claim 1, wherein the second interface comprises a graphical display associated with the mobile-communication device.

10. The telecommunication system of claim 9, wherein the graphical display is navigable by the moderator.

11. A method for controlling a conference call, the method comprising:
receiving information from a subscriber of a mobile-communication service, the information identifying the subscriber as one with moderator privileges;
communicating an access number to a mobile-communication device associated with the subscriber; and
providing executable instructions to the mobile-communication device, the executable instructions configured to interact with one or more interfaces on the mobile-communication device to expose a call feature that is inaccessible to remaining participants of a conference call.

12. The method of claim 11, wherein providing executable instructions to the mobile-communication device comprises providing logic that when executed initiates a call using the access number in response to the subscriber selecting an icon on a graphical-user interface.

13. The method of claim 11, wherein providing executable instructions to the mobile-communication device comprises providing instructions that when executed on the mobile-communication device generate a graphical user interface that identifies the call feature.

14. The method of claim 11, wherein the call feature enables the subscriber to interact with an operator of a teleconference bridge.

15. The method of claim 11, wherein the call feature affects more than one participant line connected to a conference call.

16. The method of claim 11, wherein the call feature comprises a security code.

17. The method of claim 11, wherein the call feature comprises a record operation.

18. The method of claim 11, wherein the call feature is identified via a multiple digit code entered by the subscriber identified with moderator privileges.

19. The method of claim 18, further comprising:
responding to the multiple digit code.
